(19) United States
(12) Patent Application Publication
(10) Pub. No.: US 2007/0277438 A1
(43) Pub. Date: Dec. 6, 2007

(54) System and method for producing a hydrogen enriched fuel

(75) Inventors: Franklin Earl Lynch, Bailey, CO (US); Roger W. Marmaro, Chandler, AZ (US); Gregory J. Egan, Littleton, CO (US); Justin Fulton, Fort Collins, CO (US); Gregory Solomon, Cottesloe (AU)

Correspondence Address: STEPHEN A GRATTON;THE LAW OFFICE OF STEVE GRATTON, 2764 SOUTH BRAUN WAY, LAKEWOOD, CO, 80228, US

(73) Assignee: BREHON ENERGY PLC

(21) Appl. No.: 11/442,836

(22) Filed: May 30, 2006

(51) Int. Cl. C10L 3/00; B01J 8/00

(52) U.S. Cl. 48/197 R; 48/61; 48/127.1

(57) ABSTRACT

A system for producing a hydrogen enriched fuel includes a steam reformer configured to produce an impure hydrogen-rich gas stream which includes a composition of hydrogen and impurities in selected quantities. The system also includes a blending apparatus configured to blend the impure hydrogen-rich gas stream with a hydrocarbon fuel in a predefined ratio. The system can also include a compressor, a storage container, a fuel dispensing system and a vehicle having an engine configured to burn the hydrogen enriched fuel. A method for producing the hydrogen enriched fuel includes the steps of producing the hydrogen-rich gas stream, and then blending the hydrogen-rich gas stream and the hydrocarbon fuel into the hydrogen enriched fuel at the predefined ratio.

### FIELD OF THE INVENTION

This invention relates generally to the production of hydrogen fuels, and particularly to a system and a method for producing a hydrogen enriched fuel suitable for use as an alternative fuel.

### BACKGROUND OF THE INVENTION

Gaseous alternative fuels, such as hydrogen and natural gas, are valued for their clean burning characteristics in motor vehicle engines. A particularly clean burning gaseous alternative fuel known as HYTHANE is formed from a mixture of hydrogen and natural gas. The prefix “Hy” in HYTHANE is taken from hydrogen. The suffix “thane” in HYTHANE is taken from methane, which is the primary constituent of natural gas. HYTHANE is a registered trademark of Brehon Energy PLC. HYTHANE typically contains about 5% to 7% hydrogen by energy, which corresponds to 15% to 20% hydrogen by volume. Natural gas is typically about 90+% methane, along with small amounts of ethane, propane, higher hydrocarbons, and “inerts” like carbon dioxide or nitrogen.

Various processes have been developed for producing hydrogen. These processes include electrolysis, exotic water splitting, and separation from industrial waste streams. Hydrogen can also be produced by reforming natural gas. In this case a reformer, which is one type of fuel processor, converts a hydrocarbon fuel, such as methane, propane or natural gas, into hydrogen. Most of the so called “merchant” hydrogen used in industry today is made by steam-methane reformers. Typically, a multi-step process is used to produce a high purity hydrogen gas stream, which can be used for a variety of purposes including mixture with other gases to produce an alternative fuel.

One type of reformer called a steam reformer uses a hydrocarbon fuel and steam (H₂O). In the steam reformer, the hydrocarbon fuel is reacted in a heated reaction tube containing steam (H₂O) and one or more catalysts. The primary reaction in the reformer is an equilibrium reaction:

CH₄+H₂O [symbol] CO+3H₂ I

As reaction I moves to the right, 2 moles of gas are converted to 4 moles of gas. This causes the reaction to be highly endothermic (−198 kJ/mol) and shows pressure sensitivity (Le Chatelier's Principle)—hydrogen production is enhanced at lower pressures.

All four of the substances in reaction I exist as a gas mixture in the reformer with excess steam (H₂O). In addition to the primary products, CO and H₂, a secondary equilibrium reaction occurs:

CO+H₂O [symbol] CO₂+H₂ II

This is called the “water gas shift” reaction. The reformer therefore contains five gases in varying concentrations according to equilibrium constants for reactions I and II. The equilibrium constants for reactions I and II are temperature sensitive (see FIG. 1).

A separate reactor, called a “shift reactor”, operates at a lower temperature to enhance reaction II. Usually, the overall objective of the reforming and shift reactions is to maximize hydrogen production.

The other four gases, present in varying concentrations, are impurities that must normally be removed for the production of high purity hydrogen. With respect to methane (CH₄), unreacted passage through the process is sometimes referred to as “methane slip”. For most other hydrogen applications, methane slip and carbon monoxide (CO) impurities are problems. For example, hydrogen for fuel cells must be very pure, so additional steps are needed to remove substantially all the impurities from the hydrogen (H₂), including relatively inert methane (CH₄) and carbon dioxide (CO₂), and especially carbon monoxide (CO), which poisons fuel cells. The gas stream at the exit of the shift reactor also contains water vapor (H₂O). This is substantially removed by a condenser before further purification measures are applied.

In order to make high purity hydrogen (H₂), a final pressure swing adsorption (PSA) process can be performed. The PSA process involves a high pressure adsorption of impurities from the hydrogen (H₂) onto a fixed bed of adsorbents. The impurities are subsequently desorbed at low pressure into an offgas stream, thereby producing an extremely pure hydrogen gas (H₂). For example, product purities in excess of 99.999% (H₂) by volume percentage can be achieved. The offgas stream, which includes carbon dioxide(CO₂), carbon monoxide (CO), methane (CH₄) plus small amounts of water vapor and hydrogen (H₂), is returned to the process as supplemental fuel.

An overview of a steam-methane hydrogen production process is shown in FIG. 2. In step A, methane (CH₄) and steam (H₂O) are injected into a reformer, and reacted in the presence of a catalyst to produce a hydrogen-rich gas stream. Step A is endothermic, requiring heat from an auxiliary burner or other means of heating. In step B, the hydrogen-rich gas stream is moved through a shift reactor, which reacts some of the carbon monoxide (CO) with steam to produce additional hydrogen. Step B is also endothermic, requiring heat from an auxiliary burner or other means of heating. In step C, a condensing step is performed to remove most of the water vapor (H₂O) from the hydrogen-rich gas stream. In step D, a compressing step is performed in which the hydrogen-rich gas is compressed to a desired pressure. In step E, a PSA step is performed, removing the impurities, and producing a high purity hydrogen gas. The impurities, which include carbon dioxide (CO₂), carbon monoxide (CO), methane (CH₄), residual water vapor (H₂O) and small quantities of hydrogen (H₂), can be recycled back to the boiler and/or auxiliary burners (not shown). It is also general practice to recover waste heat throughout the process with various heat exchangers (not shown).

In general, the production of a high purity hydrogen gas requires large capital costs for the compressor and PSA columns, and a significant operating cost for compressor electric power. The PSA apparatus is comprised of vessels and valves connected and separated through conduits, such as piping or tubing. It is difficult to manufacture a compact embodiment of the system.

The present disclosure is directed to a system and method for producing a hydrogen enriched fuel suitable for use as an alternative fuel, with reduced costs and increased energy efficiency relative to conventional hydrogen production systems. In the present system and method, unreacted hydrocarbons and impurities are incorporated into the hydrogen enriched fuel to reduce costs and increase energy efficiency.

The foregoing examples of the related art and limitations related therewith are intended to be illustrative and not exclusive. Other limitations of the related art will become apparent to those of skill in the art upon a reading of the specification and a study of the drawings. Similarly, the following embodiments and aspects thereof are described and illustrated in conjunction with a system and method, which are meant to be exemplary and illustrative, not limiting in scope.

### SUMMARY OF THE INVENTION

A system and a method for producing a hydrogen enriched fuel are provided. The system includes a reformer configured to react steam and a hydrocarbon to produce an impure hydrogen-rich gas stream, which comprises a composition of hydrogen and impurities in selected quantities. At a minimum, the system includes a condenser and/or other drying equipment configured to remove water vapor from the impure hydrogen-rich gas stream. The system also includes a gas blending apparatus in flow communication with the reformer and with a hydrocarbon fuel source, which is configured to blend the impure hydrogen-rich gas stream with a hydrocarbon fuel.

The system can also include a compressor configured to compress the hydrogen enriched fuel to a selected pressure, a storage container configured to store the hydrogen enriched fuel, a vehicle with an engine configured to burn the hydrogen enriched fuel, and a dispensing system configured to dispense the hydrogen enriched fuel into the vehicle. The system can be located at any convenient location, such as proximate to a refueling station for alternative fueled vehicles (AFVs). Alternately, the system can be located on board an alternative fueled vehicle (AFV).

An alternate embodiment system includes a carbon dioxide scrubber configured to remove carbon dioxide from the impure hydrogen-rich gas stream prior to blending. Another alternate embodiment system includes a shift reactor configured to convert carbon monoxide and water vapor from the impure hydrogen-rich gas stream to carbon dioxide and hydrogen prior to blending. Another alternate embodiment system includes both a shift reactor, configured to convert carbon monoxide and water vapor from the impure hydrogen-rich gas stream to carbon dioxide and hydrogen, and a scrubber configured to substantially remove carbon dioxide from the impure hydrogen-rich gas stream prior to blending.

The method includes the steps of reacting steam and a hydrocarbon to produce an impure hydrogen-rich gas stream comprising a composition of hydrogen and impurities in selected quantities. The method also includes the step of blending the impure hydrogen-rich gas stream with a hydrocarbon fuel at a predefined ratio. The method can also include the steps of compressing, storing, dispensing, and then burning the hydrogen enriched fuel. The method can optionally include the step of removing carbon dioxide from the impure hydrogen-rich gas stream prior to the blending step. The method can optionally include the step of reacting carbon monoxide with water vapor in the impure hydrogen-rich gas stream prior to removing the carbon dioxide from the impure hydrogen-rich gas stream.

### BRIEF DESCRIPTION OF THE DRAWINGS

Exemplary embodiments are illustrated in the referenced figures of the drawings. It is intended that the embodiments and the figures disclosed herein are to be considered illustrative rather than limiting.

FIG. 1 is an equilibrium concentration graph illustrating concentrations of (CH₄), (CO₂), (CO), (H₂O) and (H₂) in mole % versus temperature in OC for a steam-methane reformer process;

FIG. 2 is a block diagram illustrating a process flow in a prior art steam-methane reformer process;

FIG. 3 is a block diagram illustrating a process flow in a method for producing a hydrogen enriched alternative fuel;

FIG. 4 is a schematic view of a system for producing a hydrogen enriched fuel;

FIG. 5 is an enlarged schematic view of a gas blending apparatus of the system;

FIG. 6 is a schematic view of an alternate embodiment system having a carbon dioxide scrubber;

FIG. 7 is a schematic view of an alternate embodiment system having a shift reactor;

FIG. 8 is a schematic view of an alternate embodiment system having a shift reactor and a carbon dioxide scrubber; and

FIG. 9 is a block diagram illustrating steps in the method for producing a hydrogen enriched alternative fuel.

### DETAILED DESCRIPTION OF THE PREFERRED EMBODIMENTS

The following definitions are used in the present disclosure.

HYTHANE means a hydrogen enriched alternative fuel comprised of hydrogen and methane and impurities included in hydrogen and natural gas.

Methane slip means unreacted methane which passes through a reformer without reacting.

Pressure Swing Adsorption (PSA) means a process for adsorbing impurities from a hydrogen-rich feed gas onto a fixed bed of adsorbents at high pressure.

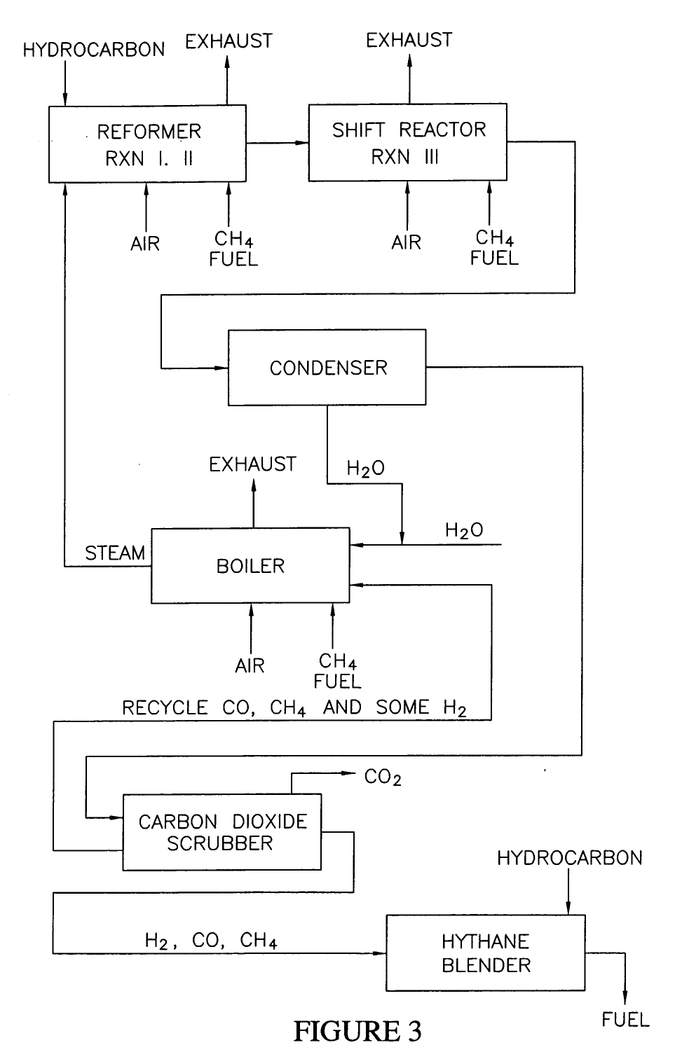

Referring to FIG. 3, a process flow in a steam-methane method for producing a HYTHANE fuel. Initially, methane (CH₄) and steam (H₂O) are injected into a reformer, and reacted in the presence of a catalyst to produce a hydrogen-rich gas stream. This step is endothermic, requiring heat from an auxiliary burner or other means of heating. Next, the hydrogen-rich gas stream is moved through a shift reactor, which reacts some of the carbon monoxide (CO) with steam to produce additional hydrogen. This step is also endothermic, requiring heat from an auxiliary burner or other means of heating. Next, a condensing step is performed to remove most of the water vapor (H₂O) from the hydrogen-rich gas stream. Next, a carbon dioxide scrubbing step is performed in which carbon dioxide is removed from hydrogen-rich. Next, a blending step is performed, where natural gas is blended with the hydrogen-rich gas stream to produce HYTHANE fuel.

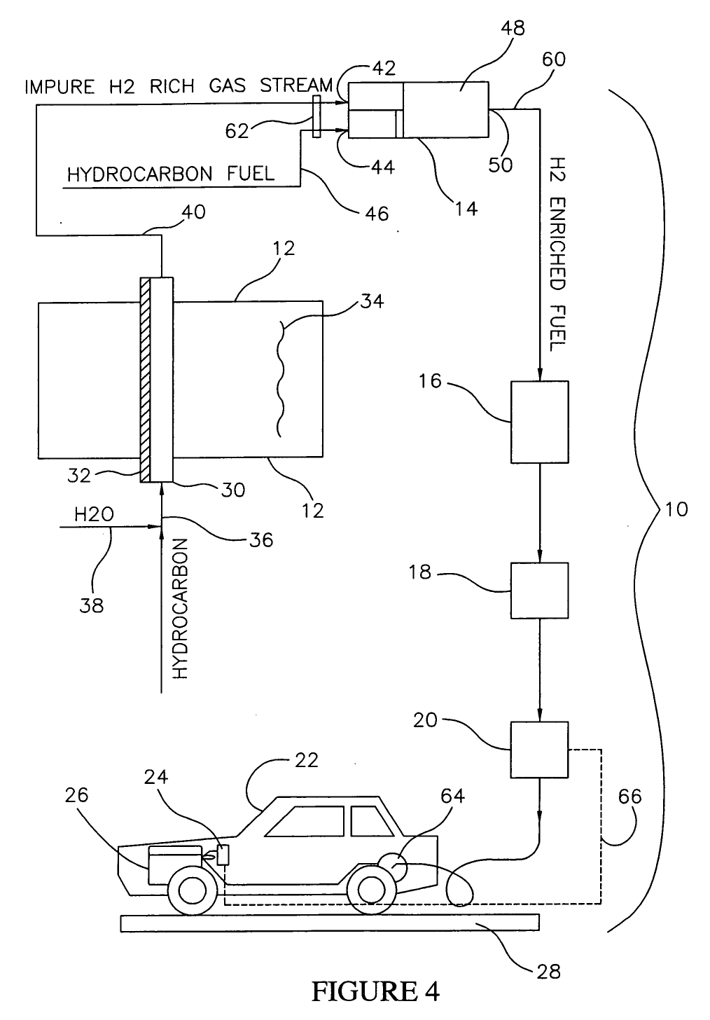

Referring to FIG. 4, a system 10 for producing a hydrogen enriched alternative fuel is illustrated. In the illustrative embodiment, the hydrogen enriched alternative fuel comprises HYTHANE which includes selected volumetric percentages of hydrogen (H₂), methane (CH₄), typical non-methane constituents of natural gas, carbon monoxide (CO), and carbon dioxide (CO₂).

As shown in FIG. 4, the system 10 includes a reformer 12 configured to react steam and a hydrocarbon to produce a hydrogen-rich gas stream containing a selected percentage of impurities. The system 10 also includes a blending apparatus 14 configured to blend the hydrogen-rich gas stream and a hydrocarbon fuel at a selected pressure and equal temperatures.

The system 10 (FIG. 4) can also include a compressor 16 configured to compress the hydrogen enriched fuel to a selected pressure, a storage system 18 configured to store the hydrogen enriched fuel, and a dispensing system 20 configured to dispense the hydrogen enriched fuel into a vehicle 22 having an engine 26 configured to burn the hydrogen enriched fuel. The vehicle 22 can also include an engine control module 24 configured to control the engine 26. The control module 24 may also gather data relating to emissions, fuel consumption, engine performance and driver competence.

In FIG. 4, the system 10 is located proximate to a refueling station 28 for alternative fueled vehicles, which is similar to a conventional gas station. However, the system 10 can also be located remote from the refueling station 28, in which case pipes or transport vehicles can be used to transport the hydrogen enriched fuel to a desired location for use or storage. As another alternative, the system 10 can be located onboard the vehicle 22.

The reformer 12 (FIG. 4) includes a reforming reaction tube 30 containing a reforming catalyst 32 configured to produce a hydrogen-rich gas stream by reacting steam and a hydrocarbon in accordance with previously described reactions I and II. By way of example, the reforming catalyst 32 can comprise any catalyst used in the art, such as a nickel based catalyst. Alternately, the reforming catalyst 32 can comprise a platinum, palladium, rhodium, ruthenium, gold, or silver catalyst, or a catalyst comprising one or more of these materials.

The reformer 12 also includes a heating element, typically a natural gas burner, 34 proximate to the reforming reaction tube 30 configured to provide energy for heating the reforming reaction tube 30, and sustaining the previously described endothermic reactions I and II to produce the hydrogen-rich gas stream. During operation, the reforming reaction tube 30 can be heated to a temperature between about 650° C. and 900° C.

The reformer 12 (FIG. 4) also includes a hydrocarbon supply conduit 36 in flow communication with an inlet of the reformer reaction tube 30. The hydrocarbon supply conduit 36 is also in flow communication with a source of a hydrocarbon. In the illustrative embodiment, the hydrocarbon comprises natural gas (NG), rich in methane (CH₄). The reformer 12 (FIG. 4) also includes a steam supply conduit, typically a natural gas-fired boiler, 38 in flow communication with the inlet of the reformer reaction tube 30 and with a supply of steam.

The reformer 12 (FIG. 4) also includes a hydrogen supply conduit 40 in flow communication with an outlet of the reaction tube 30, and with the blending apparatus 14, which is configured to supply the hydrogen-rich gas stream to the blending apparatus 14. The flow rates of the hydrocarbon, and the steam as well, can be provided to the reforming reaction tube 30 to provide the hydrogen-rich gas stream to the blending apparatus 14 at a selected flow rate.

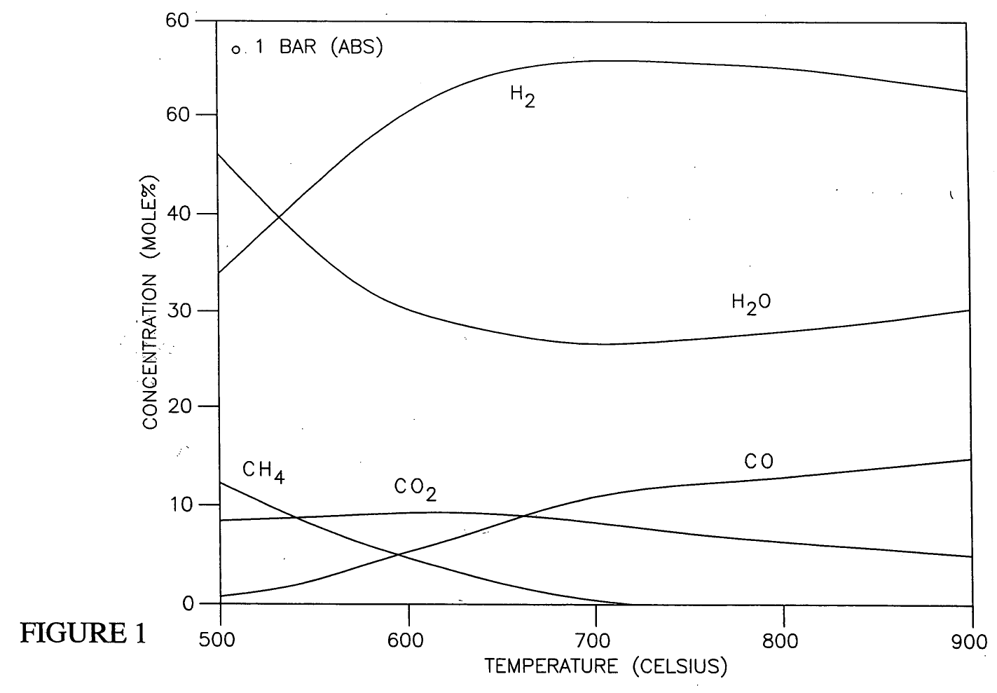

The reformer 12 (FIG. 4) is configured to produce a hydrogen-rich gas stream which contains selected volumetric percentages of hydrogen H₂, hydrocarbon (e.g., methane) and impurities. By way of example, with the hydrocarbon comprising methane (natural gas), the hydrogen-rich gas stream can have a chemical composition which includes the following volumetric percentages of compounds (derived from FIG. 1 from 650-900° C., (all percentages reported on a dry basis):
hydrogen (H₂) from 68 to 72 vol %
methane (CH₄) from 0 to 8 vol %
carbon monoxide (CO) from 14 to 20 vol %
carbon dioxide (CO₂) from 7 to 14 vol %.

In studying the literature on reformers, the inventors have ascertained that removing impurities from the hydrogen-rich gas stream requires a significant expenditure of energy. However, hydrogen is a combustion stimulant when mixed with other flammable gases. It makes fuel gas/air mixtures ignite easier, and burn faster and more completely. For these reasons, hydrogen imparts “dilution tolerance” to flammable gas mixtures. For example, a few percent of non-flammable CO₂ is a simple diluent in HYTHANE.

Unlike fuel cell applications, HYTHANE does not require high purity hydrogen. A hydrogen-rich gas stream is satisfactory for blending. In a conventional steam-methane reformer, significant amounts of energy are expended to remove impurities, such as methane, from the hydrogen-rich gas stream. However, the inventors have ascertained that removing hydrocarbons from the hydrogen-rich gas stream before mixing with the hydrocarbon fuel is counterproductive. These hydrocarbons must be replaced.

In general, the production of a high purity hydrogen-rich gas stream as taught by the prior art decreases the overall efficiency of a production process. Using the steam reformation method, the theoretical overall energy conversion efficiency from methane (CH₄) to hydrogen (H₂) is approximately 90%. However, in practice, the actual energy conversion is in the range of 50%-80%, after accounting for fuel consumed for steam production, reformer heat, shift reactor heat and electrical energy for processing (compressors, etc.). The best of reformers make efficient use of waste heat throughout the process.

In the system 10 (FIG. 4), the blending apparatus 14 (FIG. 4) is configured to mix the hydrogen-rich gas stream produced by the reactor 12 with a hydrocarbon fuel gas or vapor to produce the hydrogen enriched fuel. In the illustrative embodiment, the reformer 12 (FIG. 4) and the blending apparatus 14 (FIG. 4) are constructed and operated to produce HYTHANE having a selected chemical composition.

As shown in FIG. 4, the blending apparatus 14 includes a hydrogen inlet 42 in flow communication with the hydrogen supply conduit 40. The blending apparatus 14 also includes a hydrocarbon inlet 44 in flow communication with a hydrocarbon supply conduit 46. The hydrocarbon supply conduit 46 is in flow communication with a hydrocarbon fuel source configured to supply the hydrocarbon fuel in a gaseous state to the blending apparatus 14. In the illustrative embodiment, the hydrocarbon fuel comprises methane in the form of natural gas.

As shown in FIG. 4, the system 10 can also include a heat exchanger 62 operably associated with the hydrogen supply conduit 40 and with the hydrocarbon supply conduit 46. The heat exchanger 62 is configured to equilibrate the hydrogen and the hydrocarbon fuel to a common temperature prior to blending. A representative range for the common temperature can be from −20° C. to +40° C.

The flow rates for the hydrogen supply conduit 40 (FIG. 4) and the hydrocarbon supply conduit 46 (FIG. 4) can be selected as required. For example, a representative flow rate for the hydrogen supply conduit 40 (FIG. 4) can be about 1 cubic meter per minute at a minimum pressure of 4 bar gauge A representative flow rate for the hydrocarbon supply (mostly CH₄) conduit 46 (FIG. 4) can be about 4 cubic meters per minute at a minimum pressure of 4 bar gauge. The size of the hydrocarbon supply conduit 46 (FIG. 4) can be selected as required with a 50 mm conduit being representative. The size of the hydrogen supply conduit 40 (FIG. 4) can also be selected as required with a 15 mm conduit being representative.

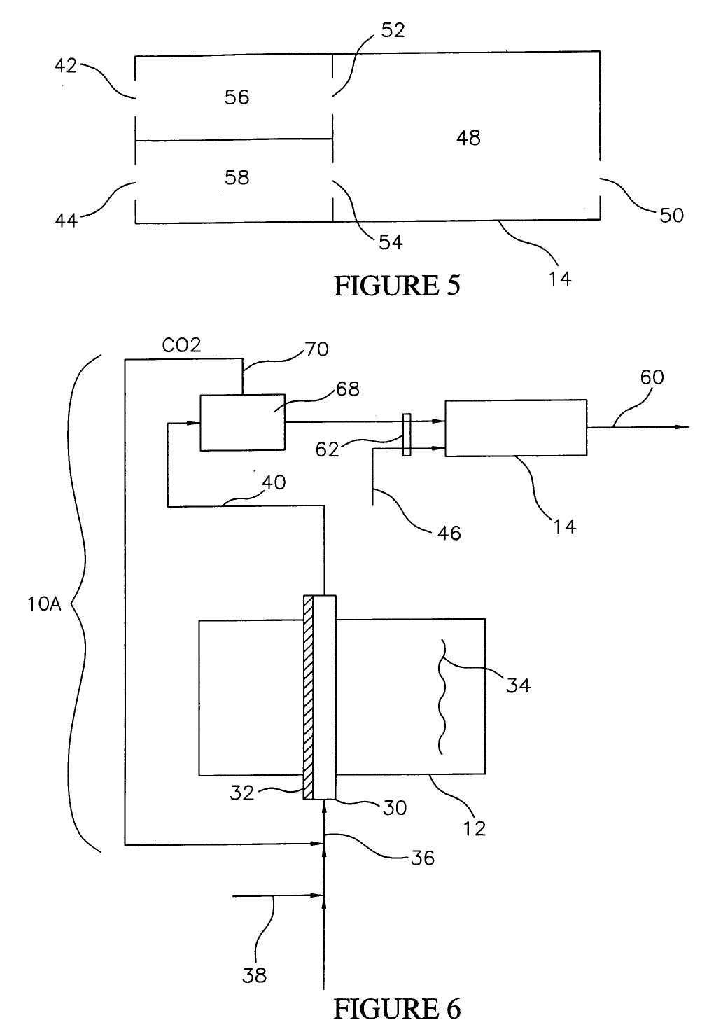

As shown in FIG. 5, the blending apparatus 14 also includes a hydrogen inlet chamber 56 in flow communication with the hydrogen inlet 42, and a hydrocarbon inlet chamber 58 in flow communication with the hydrocarbon inlet 44. The blending apparatus 14 also includes a blending chamber 48 in flow communication with the hydrogen inlet chamber 56 and with the hydrocarbon inlet chamber 58. The blending chamber 48 is connected to the hydrogen inlet chamber 56 via a hydrogen sonic orifice 52. In addition, the blending chamber 48 is connected to the hydrocarbon inlet chamber 58 via a hydrocarbon sonic orifice 52. The blending chamber 48 is configured to blend the hydrogen-rich gas stream and the hydrocarbon fuel stream, at a selected ratio to produce the hydrogen enriched alternative fuel with a selected composition. A constant blending ratio is necessary to produce the hydrogen enriched fuel with uniform characteristics for use as a combustible fuel. An uneven blending ratio may produce a fuel with unwanted characteristics. Quality control measures are necessary to ensure the desired ratio (e.g., thermal conductivity analysis).

During operation of the system 10 (FIG. 4), the flow rates of the hydrogen enriched gas stream and the hydrocarbon fuel stream, and the sizes of the inlets 42, 44 (FIG. 5) and inlet chambers 56, 58 (FIG. 5), can be selected to achieve the selected ratio of hydrogen to hydrocarbon. A representative ratio of H₂ by volume in CH₄ can preferably be from 15 to 20 vol % of H₂ in CH₄. For example, it has been determined that a hydrogen content of 15% by volume causes HYTHANE to burn very much like gasoline in engines that are designed for gasoline (stoichiometric engines). Similar results can be obtained with as little as 10% hydrogen by volume. For another example, it has been determined that a hydrogen content of 20% by volume in HYTHANE is optimum in lean burn engines for the reduction of NOx emissions (by about 50% vs. NG), without any penalty in efficiency, power, or hydrocarbon emissions. More hydrogen than 20% by volume will allow leaner operation, but lower NOx is not possible without a sacrifice in efficiency, power, or hydrocarbon emissions (due to lower exhaust temperatures in the oxidation catalyst at leaner conditions). Similar results can be obtained with as much as 25% hydrogen by volume with attendant penalties in fuel volume and fuel cost. With these examples of stoichiometric and lean burn combustion in mind, hydrogen concentrations in the range from 10-25% by volume are of interest.

As shown in FIG. 4, the blending chamber 48 and the outlet 50 of the blending apparatus 14 are in flow communication with a hydrogen enriched fuel conduit 60. The hydrogen enriched fuel flows out of the blending chamber 48 and the outlet 50 of the blending apparatus 14 into the hydrogen enriched fuel conduit 60.

Further details of the blending apparatus 14 (FIG. 4) including a control system, are disclosed in U.S. application Ser. No. 11/348,193 filed Feb. 2, 2006 entitled “System And Method For Producing, Dispensing, Using And Monitoring A Hydrogen Enriched Fuel”, which is incorporated herein by reference. The blending apparatus is also described in U.S. application Ser. No. 11/411,766 filed Apr. 26, 2006 entitled “System And Method For Blending And Compressing Gases”, which is incorporated herein by reference.

As shown in FIG. 4, the hydrogen enriched fuel conduit 60 is in flow communication with the compressor 16, which is configured to compress the hydrogen enriched fuel to a selected pressure. A representative range for the selected pressure can be from 200 bar gauge to 350 bar gauge for useful vehicle storage. For some applications, the compressor 16 can be eliminated, and the hydrogen enriched fuel can be supplied to a low pressure storage system 18, or directly to a stationary engine.

As shown in FIG. 4, the compressor 16 is in flow communication with the storage system 18, which is configured to store the hydrogen enriched fuel for future use. However, for some applications, termed “slow fill”, the storage system 18 can be eliminated, and the hydrogen enriched fuel can be supplied directly to the dispensing system 20 and the vehicle 22.

Previously incorporated application Ser. No. 11/273,397 describes a storage system 18 in the form of a cascade of storage tanks located at the refueling station 28 (FIG. 4). Such a system is termed “fast fill”. At least the final stage of the cascade can be kept at a significantly higher pressure than the maximum pressure of the vehicle fuel tank 64, in order to dispense fuel quickly from the dispensing system 20 (FIG. 4) into the vehicle fuel tank 64. Without high pressure storage, only slow-fill dispensing is possible, which is not practical for large fleets of high-utilization vehicles.

As shown in FIG. 4, the storage system 18 is in flow communication with the dispensing system 20 which is configured to dispense the hydrogen enriched fuel into the vehicle fuel tank 64. The dispensing system 20 can be constructed as described in previously incorporated application Ser. No. 11/273,397. In addition, the dispensing system 20 can be in signal communication with the engine control module 24, as indicated by signal lines 66, as described in previously incorporated application Ser. No. 11/273,397. This permits data relating to emissions, fuel consumption, engine performance and driver competence to be collected and monitored.

Referring to FIG. 6, an alternate embodiment system 10A is constructed substantially as previously described for system 10 (FIG. 4). However, the system 10A also includes a carbon dioxide scrubber 68 in flow communication with the reformer 12, which is configured to remove carbon dioxide from the hydrogen-rich gas stream. By way of example, the system 10A (FIG. 6) can be economically configured to reduce carbon dioxide to 1-2% by volume in the hydrogen-rich gas stream. Small amounts of CO₂ are acceptable in HYTHANE.

Although not essential, the carbon dioxide scrubber 68 can be beneficial for some applications. For example, a large percentage of carbon dioxide (e.g., 14% carbon dioxide), requires an increased volume for the vehicle fuel tank 64 (FIG. 4). Although removing carbon dioxide increases costs, a balance of costs is required between the additional carbon dioxide scrubbing step, and the costs of the vehicle fuel tank 64 (FIG. 4). Depending on the additional cost of the vehicle fuel tank 64 (FIG. 4), it may be beneficial to use a larger volume vehicle fuel tank 64 (FIG. 4) rather than scrubbing out excess carbon dioxide from the hydrogen-rich gas stream.

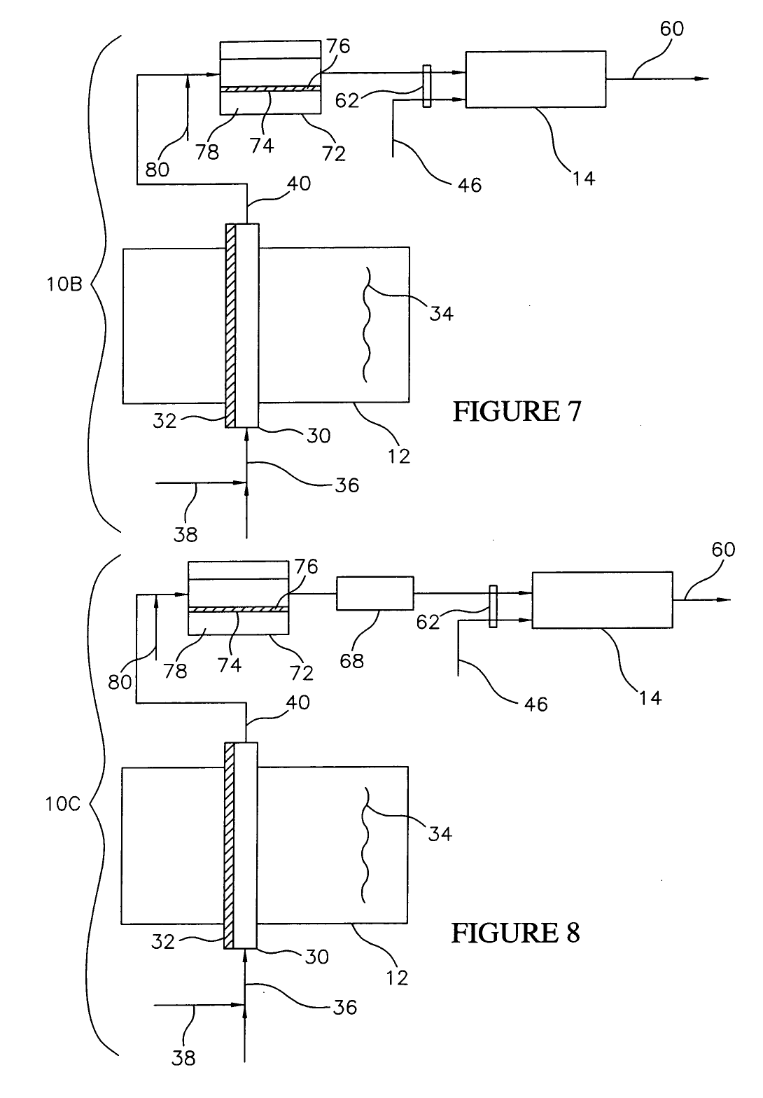

Referring to FIG. 7, an alternate embodiment system 10B is constructed substantially as previously described for system 10 (FIG. 4). However, the system 10B also includes a shift reactor 72 in flow communication with the reformer 12, which is configured to react excess carbon monoxide with steam in the hydrogen-rich gas stream to form carbon dioxide and additional hydrogen. The shift reactor 72 includes a reaction tube 74 containing a catalyst 76 for reacting carbon monoxide and water from a steam supply conduit 80. The shift reactor 72 also includes a heating element, typically a natural gas burner, 78 proximate to the reaction tube 74 which is configured to provide heat to the shift reactor 72 and to the reaction tube 74. In the reaction tube 74, carbon monoxide in the hydrogen-rich gas stream reacts with water endothermically to produce additional hydrogen and carbon dioxide. The hydrogen-rich gas stream flows from the shift reactor 72 into the blending apparatus 14 for blending substantially as previously described.

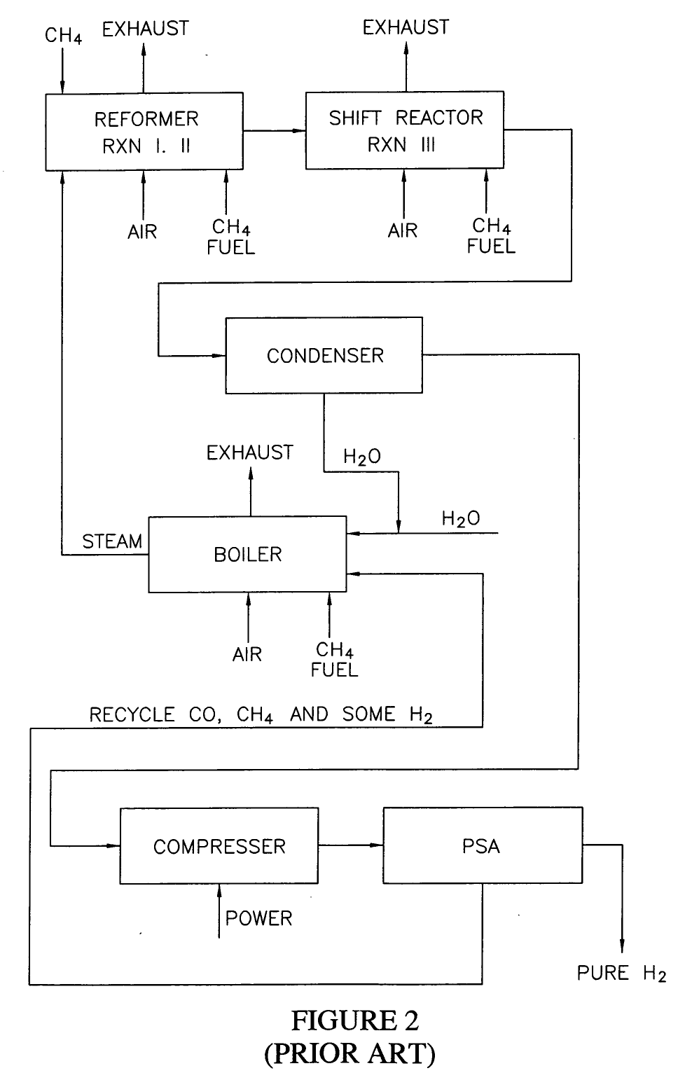

Although not essential, the shift reactor 72 (FIG. 7) can be beneficial for some applications. Typically, the reformer 12 (FIG. 4) does not eliminate carbon monoxide from the hydrogen-rich gas stream. However, the tolerance of HYTHANE for impurities enables the simplification of a conventional steam-methane reformer hydrogen process (FIG. 2) to the system 10 (FIG. 4). In general, carbon monoxide is a flammable gas, like hydrogen and methane, with a relatively wide flammability range. Pure carbon monoxide burns in air to form carbon dioxide after an unusually long ignition delay period. Carbon monoxide poisons hydrogen fuel cells, and is always removed in the production of high purity hydrogen for use in fuel cell applications. However, carbon monoxide is an acceptable ingredient of HYTHANE.

A problem with carbon monoxide in HYTHANE is it's characteristic as a toxic gas. A typical HYTHANE blend, called HY-5, contains 5% hydrogen by energy content in methane. That corresponds to 15% hydrogen by volume. Discounting the methane that is already in the hydrogen and removing the carbon dioxide, typically leaves a 70/10 ratio of hydrogen/CO. Diluting this with natural gas to achieve 15% hydrogen by volume, the CO in HY-5 becomes about 2% of the mixture or 20,000 ppm. Breathing pure HYTHANE with that much CO would be very toxic. HYTHANE is not available for breathing until it leaks out of a container. If leaking occurs, the primary safety hazard is flammability. The lower flammability limit of HY-5 is about 4% by volume. The CO concentration in this fuel air mixture is 800 ppm. Brief exposure to 800 ppm is not lethal. The hazard from the toxicity of carbon monoxide in HYTHANE occurs at approximately the same concentrations at which flammability also becomes hazardous.

Referring to FIG. 8, an alternate embodiment system 10C is constructed substantially as previously described for system 10 (FIG. 4). However, the system 10C also includes both the shift reactor 72 and the carbon dioxide scrubber 68 for removing impurities from the hydrogen-rich gas stream.

It is desired for certain applications to produce a hydrogen-rich gas reformate with a specific composition. The reforming step is temperature sensitive, and the specific composition of the hydrogen-rich gas is dependent on the temperature of the reaction inside the reformer 12. By controlling the temperature of the reformer, a specific composition reformate can be produced. As shown in FIG. 1, the composition of hydrogen, water, methane, carbon monoxide and carbon dioxide by molar percentage are all directly related to the pressure and temperature of the reformer 12. The composition would also contain small amounts of non-methane hydrocarbons, and nitrous-oxide, which make up the remaining composition of the reformate hydrogen-rich gas. After drying, the additional steps of the process, such as removing carbon dioxide, can be used to further create a reformate with the specific chemical composition desired. A particularly desired hydrogen-rich gas reformate is comprised of 68% to 72% by volume of hydrogen, 4% to 6% by volume of methane, 9% to 11% by volume of carbon dioxide, 0.1% to 0.3% by volume of carbon monoxide, 1% to 3% non-methane hydrocarbons, and 1% to 3% nitrous oxide.

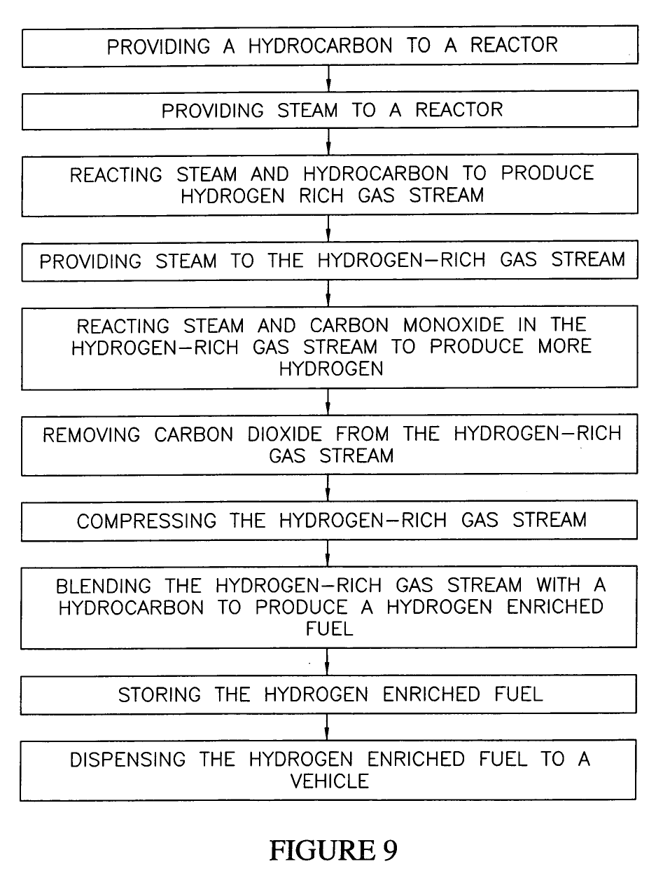

FIG. 9 illustrates the steps in a method for producing a hydrogen enriched alternative fuel. As previously explained, depending on the system used to perform the method and the application, some of these steps not not be performed. For example, for some applications the storing step can be eliminated.

The steps of the method of FIG. 9 include:

Providing a hydrocarbon to a reactor.

Providing steam to the reactor.

Reacting the steam and hydrocarbon to produce a hydrogen-rich gas stream.

Providing steam to the hydrogen-rich gas stream.

Reacting steam and carbon monoxide in the hydrogen-rich gas stream to produce more hydrogen.

Removing carbon dioxide from the hydrogen-rich gas stream.

Compressing the hydrogen-rich gas stream.

Blending the hydrogen-rich gas stream with a hydrocarbon to produce a hydrogen enriched fuel.

Storing the hydrogen enriched fuel.

Dispensing the hydrogen enriched fuel to a vehicle.

Thus the invention provides an improved system and method for blending a hydrogen enriched fuel. While the invention has been described with reference to certain preferred embodiments, as will be apparent to those skilled in the art, certain changes and modifications can be made without departing from the scope of the invention as defined by the following claims.

1. A system for producing a hydrogen enriched fuel comprising:
a reformer configured to react water vapor (steam) and a hydrocarbon in the presence of a catalyst to form a hydrogen-rich gas comprising hydrogen and impurities in selected quantities; and
a gas blending apparatus in flow communication with the reformer and with a source of a hydrocarbon fuel configured to blend the hydrogen-rich gas and the hydrocarbon fuel at a predefined ratio.

2. The system of claim 1 wherein the hydrocarbon comprises methane, and the hydrogen-rich gas comprises selected volumetric percentages of hydrogen, methane, carbon monoxide, and carbon dioxide.

3. The system of claim 2 wherein the hydrogen-rich gas comprises from 50% to 75% by volume of hydrogen, from 0% to 20% by volume of methane, from 5% to 20% by volume of carbon monoxide, and from 5% to 15% by volume of carbon dioxide.

4. The system of claim 1 wherein the hydrocarbon fuel comprises methane, and the hydrogen enriched fuel comprises selected volumetric percentages of hydrogen, methane, carbon monoxide, and carbon dioxide.

5. The system of claim 4 wherein the hydrogen enriched fuel comprises from 10% to 25% by volume of hydrogen, from 62% to 88% by volume of methane, from 1% to 7% by volume of carbon monoxide, and from 1% to 5% by volume of carbon dioxide.

6. The system of claim 1 further comprising a storage system in flow communication with the gas blending apparatus configured to store the hydrogen enriched fuel.

7. The system of claim 1 further comprising a dispensing system configured to dispense the hydrogen enriched fuel to a vehicle.

8. The system of claim 1 further comprising a carbon dioxide scrubber in flow communication with the reformer configured to remove carbon dioxide from the hydrogen-rich gas stream.

9. The system of claim 1 further comprising a shift reactor in flow communication with the reformer configured to react carbon monoxide in the hydrogen-rich gas stream with steam to form additional hydrogen and carbon dioxide

10. The system of claim 1 further comprising a shift reactor in flow communication with the reformer configured to react carbon monoxide in the hydrogen-rich gas stream with steam to form additional hydrogen and carbon dioxide and a carbon dioxide scrubber in flow communication with the shift reactor configured to remove carbon dioxide from the hydrogen-rich gas stream.

11. The system of claim 1 wherein the blending apparatus comprises a hydrogen-rich gas chamber configured to receive the hydrogen-rich gas, a hydrocarbon fuel chamber configured to receive the hydrocarbon fuel, and a blending chamber in flow communication with the hydrogen chamber and the hydrocarbon fuel chamber configured to mix the hydrogen-rich gas and the hydrocarbon fuel.

12. The system of claim 1 wherein the system is located proximate to a refueling station for alternative fueled vehicles.

13. The system of claim 1 wherein the hydrogen-rich gas is comprised of 68% to 72% by volume of hydrogen, 4% to 6% by volume of methane, 9% to 11% by volume of carbon dioxide, 0.1% to 0.3% by volume of carbon monoxide, 1% to 3% non-methane hydrocarbons, and 1% to 3% nitrous oxide.

14. A system for producing a hydrogen enriched fuel comprising:
a reformer configured to react water and a first methane gas in the presence of a catalyst to form a hydrogen-rich gas comprising hydrogen, methane, carbon dioxide, carbon monoxide with selected volumetric percentages; and
a gas blending apparatus in flow communication with the reformer and with a source of a second methane gas configured to blend the hydrogen-rich gas and the second methane gas to provide the hydrogen enriched fuel with from 10 to 25 vol % of hydrogen.

15. The system of claim 14 further comprising a dispensing system configured to dispense the hydrogen enriched fuel into a vehicle having an engine configured to burn the hydrogen enriched fuel.

16. The system of claim 14 wherein the system is located proximate to a refueling station for alternative fueled vehicles.

17. The system of claim 14 wherein the first methane gas and the second methane gas comprise natural gas.

18. The system of claim 14 wherein the hydrogen-rich gas comprises from 50% to 75% by volume of hydrogen, from 0% to 20% by volume of methane, from 5% to 20% by volume of carbon monoxide, and from 5% to 15% by volume of carbon dioxide.

19. The system of claim 14 wherein the hydrogen enriched fuel comprises from 10% to 25% by volume of hydrogen, from 62% to 88% by volume of methane, from 1% to 7% by volume of carbon monoxide, and from 1% to 5% by volume of carbon dioxide.

20. The system of claim 14 wherein the blending apparatus comprises a hydrogen-rich gas chamber configured to receive the hydrogen-rich gas, a hydrocarbon fuel chamber configured to receive the hydrocarbon fuel, and a blending chamber in flow communication with the hydrogen chamber and the hydrocarbon fuel chamber configured to mix the hydrogen-rich gas and the hydrocarbon fuel.

21. A method for producing a hydrogen enriched alternative fuel comprising:
reacting steam and a hydrocarbon to produce an impure hydrogen-rich gas stream comprising hydrogen and impurities in selected quantities; and
blending the impure hydrogen-rich gas stream with a hydrocarbon fuel at a predefined ratio of impure hydrogen-rich gas stream to hydrocarbon fuel.

22. The method of claim 21 further comprising following the blending step, compressing the hydrogen enriched fuel to a selected pressure.

23. The method of claim 21 further comprising following the blending step, storing the hydrogen enriched fuel.

24. The method of claim 21 further comprising following the blending step, dispensing the hydrogen enriched fuel into a vehicle having an engine configured to burn the hydrogen enriched fuel.

25. The method of claim 21 further comprising removing carbon dioxide from the impure hydrogen-rich gas prior to the blending step.

26. The method of claim 21 further comprising reacting carbon monoxide from the impure hydrogen-rich gas with steam to form carbon dioxide and additional hydrogen prior to the blending step.

27. The method of claim 21 wherein the impure hydrogen-rich gas comprises from 50% to 75% by volume of hydrogen, from 0% to 20% by volume of methane, from 5% to 20% by volume of carbon monoxide, and from 5% to 15% by volume of carbon dioxide.

28. The method of claim 21 wherein the hydrogen enriched fuel comprises from 10% to 25% by volume of hydrogen, from 62% to 88% by volume of methane, from 1% to 7% by volume of carbon monoxide, and from 1% to 5% by volume of carbon dioxide.

29. The method of claim 21 wherein the reacting step and the blending step are performed at a refueling station for a vehicle.

30. The method of claim 21 wherein the reacting step and the blending step are performed on board a vehicle.

31. The method of claim 21 further comprising following the blending step, burning the hydrogen enriched fuel in an engine of a vehicle.

32. The method of claim 21 wherein the blending step is performed in a blender comprising a hydrogen chamber configured to receive the impure hydrogen-rich gas, a hydrocarbon fuel chamber configured to receive the hydrocarbon fuel, and a blending chamber in flow communication with the hydrogen chamber and the hydrocarbon fuel chamber configured to mix the impure hydrogen-rich gas and the hydrocarbon fuel.

33. The method of claim 21 wherein the hydrogen-rich gas is comprised of 68% to 72% by volume of hydrogen, 4% to 6% by volume of methane, 9% to 11% by volume of carbon dioxide, 0.1% to 0.3% by volume of carbon monoxide, 1% to 3% non-methane hydrocarbons, and 1% to 3% nitrous oxide.
